(19) United States
(12) Patent Application Publication
(10) Pub. No.: US 2006/0159982 A1
(43) Pub. Date: Jul. 20, 2006

(54) Electrode for fuel cell and fuel cell using same

(76) Inventors: Tsutomu Yoshitake, Tokyo (JP); Takashi Manako, Tokyo (JP); Hidekazu Kimura, Tokyo (JP); Ryota Yuge, Tokyo (JP); Yoshimi Kubo, Tokyo (JP); Akihiro Katsuya, Kanagawa (JP)

Correspondence Address: SUGHRUE MION, PLLC, 2100 PENNSYLVANIA AVENUE, N.W., SUITE 800, WASHINGTON, DC, 20037, US

(21) Appl. No.: 10/546,042

(22) PCT Filed: Feb. 17, 2004
(86) PCT No.: PCT/JP04/01720

§ 371 Date: Aug. 17, 2005

(30) Foreign Application Priority Data
Feb. 18, 2003 (JP) 2003-040065

(51) Int. Cl. H01M 4/86

(52) U.S. Cl. 429/44; 429/42

(57) ABSTRACT

In fuel cell (100), a metal fiber sheet is employed for a base member (104) and a base member (110) that composes a fuel electrode (102) and an oxidant electrode (108).

### FIELD OF THE INVENTION

The present invention relates to an electrode for a fuel cell and a fuel cell that employs thereof.

### DESCRIPTION OF THE RELATED ART

With the advent of the information-intensive society in recent years, quantity of information to be treated in electronic devices such as personal computer and the like is infinitely increased, and correspondingly, power consumption of the electronic devices has also been considerably increased. In particular, an increase of the power consumption is a major concern in mobile electronic devices, with an increase in the processing power thereof. Currently, lithium-ion battery is generally employed for a power supply in such types of mobile electronic devices, and an increasing level of energy density of the lithium-ion battery approaches a theoretical limitation. Therefore, there has been a limitation that the power consumption should be reduced by suppressing drive frequency of central processing unit (CPU), in order to provide longer continuous duty period of the mobile electronic devices.

In such circumstances, it is expected that the continuous duty period of the mobile electronic device be considerably improved by employing a fuel cell having larger energy density as a power supply for an electronic device, in place of the lithium-ion battery.

The fuel cell is configured of a fuel electrode and an oxidant electrode (hereinafter, these are referred to as “catalyst electrode”) and an electrolyte provided therebetween, and a fuel is supplied to the fuel electrode, and an oxidant is supplied to the oxidant electrode, thereby producing electric power via a chemical reaction. While hydrogen is generally employed for fuel, methanol, which is cheap and easy to be handled, is employed as a source material in recent years, and developments of fuel cells such as a methanol-reforming type fuel cell that produces hydrogen by reforming methanol, or a direct type fuel cell that directly utilizes methanol as fuel, are actively conducted.

When hydrogen was employed as the fuel, reaction at the fuel electrode is presented as the following formula (1):
3H₂→6H⁺+6e⁻ (1).

When methanol is employed as the fuel, reaction at the fuel electrode is presented as the following formula (2):
CH₃OH+H₂O→6H⁺+CO₂+6e⁻ (2).

Further, in either case, reaction with an oxidant electrode reaction is presented as the following formula (3):
3/2O₂+6H⁺+6e⁻→3H₂O (3).

In particular, since hydrogen ion can be obtained from methanol aqueous solution in the direct type fuel cell, reforming apparatus or the like is not required, and thus larger benefit for applying thereof to the mobile electronic device can be obtained. Further, since the liquid methanol aqueous solution is employed for the fuel, it is characterized in that much higher energy density can be obtained.

In order to apply the direct methanol-type fuel cell to the power supply of the mobile device such as portable telephone or laptop personal computer, reductions in size and weight of the battery is critical. However, a basic structure of a unit cell, which is a power generation element for the conventional fuel cell for the mobile device, generally comprises a structure, in which a porous gas-diffusion layer made of carbon is provided on the outside of a Membrane Electrode Assembly consisting of a catalyst electrode and a solid electrolyte membrane, and a power collection electrode is provided on the further outside thereof. In this case, the cell at least has a quint-layer structure composed of power collection electrode/gaseous diffusion layer/Membrane Electrode Assembly/gas-diffusion layer/power collection electrode, thereby involving complex structure.

Further, since a certain level of thickness is required for the metal power collection electrode, in order to achieve better electrical contact between the gas-diffusion layer formed of carbon and the metal power collection electrode, it is difficult to provide a reduced thickness of the cell, and also difficult to provide a reduced weight thereof.

Consequently, a cell for the fuel cell having an improved generating efficiency has been developed by replacing the gas-diffusion layer formed of carbon with a less-porous metal gas-diffusion layer having lower resistance. In this case, two types of structures for the cell are proposed. One structure employs a foamed metal for the gas-diffusing layer, instead of porous carbon and also employs a power collection electrode made of bulk metal similarly as in the conventional cell, as described in patent document 1. While the problem on the electrical contact is reduced in this configuration, the structural complexity is still remained.

Another structure employs a porous metal material such as foamed nickel as the gas-diffusion layer and the power collection member, as described in patent document 2. In this case, a reduction in the thickness and a miniaturization of the cell can be achieved by serving a combined function of the gas-diffusion layer and the power collection member. However, in such case, a carbon layer must be provided as an anticorrosion layer between the catalyst layer and the power collection member layer. Thus, structural complexity is also remained in this case. In addition, the contact resistance in an interface between a portion of the carbon layer and the porous metal is high.

In addition, since the foamed metal such as foamed nickel employed in the above-described document has a structure having a bonded member with particulate metals, the foamed metal is a material having relatively higher resistance in the surface when the foamed metal is formed as a sheet-like product. In addition, the resistance in the surface may fluctuate due to the factor of the manufacturing process. Therefore, there is a room for improving power generation characteristics.

On the contrary, a fuel cell employing a sheet having a porous structure is described in patent document 3. However, the specific disclosure of the document is limited to a disclosure of a fuel cell that employs a sheet consisting of polyacrylonitrile (PAN) containing carbon fiber. Carbon fiber generally has relatively higher electrical resistance, similarly as the above-described gas-diffusion layer of carbon, Thus, there is a certain limitation for providing an improvement in the performances of the fuel cell. Since the use of the metal power collection electrode is also required, miniaturization and weight reduction are also difficult.

Further, an electrochemical device that employs fiber of a metal such as stainless steel (SUS) is described in patent document 4, a gas sensor, a purifier, an electrolyte layer, and a fuel cell are listed as specific examples thereof. Although an exemplary generation of hydrogen by electrolysis is disclosed in the examples in such patent document, there is no description on a configuration of a fuel cell that actually functions as a battery. In particular, there is no description on a measure for moving proton generated by a catalyst to a solid electrolyte membrane, and no specific disclosure of the fuel cell that actually operates.

Patent document 1: Japanese Patent Laid-Open No. H06-5,289;

Patent document 2: Japanese Patent Laid-Open No. H06-223,836;

Patent document 3: Japanese Patent Laid-Open No. 2000-299,113; and

Patent document 4: Japanese Patent Laid-Open No. H06-267,555.

### SUMMARY OF THE INVENTION

The present invention has been provided in view of the foregoing situation, and an object of the present invention is to provide a technique that is capable of providing a fuel cell having reduced size and weight. It is another object of the present invention to provide a technique that is capable of providing improved output characteristics of the fuel cell. It is another object of the present invention to provide a technique that is capable of providing a simplified process for manufacturing a fuel cell.

According to one aspect of the present invention, there is provided an electrode for a fuel cell, comprising a metal fiber sheet and catalyst electrically coupled to the metal fiber sheet, wherein the metal fiber sheet comprises an alloy containing, as constituent elements, at least a metal selected from Si and Al, Fe and Cr, wherein content of Cr in the alloy is not less than 5% wt. and not more than 30% wt., and wherein combined contents of Si and Al in the alloy are not less than 3% wt. and not more than 10% wt.

Better electroconductive and better resisting properties such as acid resistance are required for the electrode of the fuel cell. Since the electrode according to the present invention is composed of the metal fiber sheet composed of the alloy having the specified composition described above, better balancing among these properties are provided. In particular, since Si or Al is contained as the alloy composition and the combined contents of Si and Al are not less than 3% wt. and not more than 10% wt., an improved durability is presented, and a better electroconductivity is stably achieved for the longer-term use.

In the present invention, the metal fiber sheet is a sheet-like product formed by molding one or more metal fibers. It may be configured by one type of metal fiber, or may contain two or more types of metal fibers. This metal fiber sheet exhibits an electric resistance, which is one or more orders of magnitude less than that of a carbon paper that is conventionally employed as an electrode material. Further, since it is the sheet provided by bonding the metal fibers, resistance on the surface is smaller and the fluctuation thereof is smaller, as compared with a conventionally employed porous metal material that is formed by joining the particle-shaped metal such as foamed metal. Further, the metal fiber sheet of the present invention is a material that has better acid resistance and mechanical strength, and better permeability for gas and aqueous solution. Therefore, it can be preferably employed as an electrode for the fuel cell that has improved power collection characteristics, and thus the output characteristics and the durability of the fuel cell can be improved.

Here, in the electrode for the fuel cell according to the present invention, the manner for coupling the catalyst is not particularly limited provided that the catalyst is electrically coupled to the metal fiber sheet. It may be directly supported on the surface of the metal fiber sheet, or may be coupled through a support material such as catalyst-supporting carbon particles. Further, an electroconductive coating layer may be formed on the surface of the metal fiber sheet, and the catalyst may be supported thereon via the coating layer.

In addition, since the electrode for the fuel cell according to the present invention has improved power collection characteristics, the use thereof avoids a need for providing the power collection member outside of electrode and coupling thereof. Thus, reduction in the size and the weight of, and reduction in the thickness of the fuel cell can be achieved.

In the aspect of the present invention, a configuration may be, employed, in which a porosity of the metal fiber sheet is, for example, not less than 20% and not more than 80%. In addition, an average line size (diameter) of the metal fiber may be from 20 to 100 μm. Having such configuration, appropriate voids are formed in the metal sheet, thereby smoothly implementing a supply and a drain of the water. In addition, proton conductors can be suitably disposed in the voids to present better proton conductivity.

In the electrode for the fuel cell according to the aspect of the present invention, a configuration may be employed, in which the porosity of one surface of the metal fiber sheet is larger than the porosity of the other surface thereof. Having such configuration, both of the permeability for the gas through the metal fiber sheet and the transfer-ability of electrons can be suitably ensured. Therefore, supply of the fuel or the oxidant to the fuel cell, discharge of carbon dioxide and the like generated by the electrochemical reaction, or power collection characteristics can be improved.

In the electrode for the fuel cell according to the aspect of the present invention, a configuration may be employed, in which the metal fiber sheet is a sintered body of a metal fiber. Since the metal fibers can be more tightly joined together by forming the sintered body, contact resistance can be reduced, thereby providing improved electrode characteristics.

In the electrode for the fuel cell according to the aspect of the present invention, a configuration may be employed, in which the catalyst is supported on a surface of a metal fiber that composes the metal fiber sheet. While the metal fibers are connected to the catalyst through carbon particles in the conventional fuel cell, the use of the configuration according to the present invention avoids the generations of the contact resistances between the carbon particles and the catalyst and the contact resistances between the metal fibers and the carbon particles, thereby providing improved transfer-ability of electrons. Here, an electroconductive coating layer may be formed on the surface of the metal fiber sheet in the present invention, the catalyst is also directly supported on the surface of the metal fiber through the coating layer in this case. Further, a catalyst layer containing carbon particles that supports the catalyst may be formed on the surface of the metal fiber sheet.

In the electrode for the fuel cell according to the aspect of the present invention, a configuration may be employed, in which a plating layer of a catalyst is formed on the surface of the metal fiber that composes the metal fiber sheet. Having such configuration, the desired catalyst can be simply and surely supported on the surface of the porous metal sheet.

In the electrode for the fuel cell according to the aspect of the present invention, a configuration may be employed, in which the metal fiber composing the metal fiber sheet has a roughened surface. Having such configuration, the specific surface area of the metal fiber sheet can be increased. Thus, the quantity of the supported catalyst is increased, thereby improving the electrode characteristics.

Here, in the present invention, the configuration having a roughened surface indicates a configuration, in which the surfaces of the metal fibers that compose the metal fiber sheet are roughed.

In the electrode for the fuel cell according to the aspect of the present invention, a configuration may be employed, which further comprises a proton conductor having a contact with the catalyst. Having such configuration, the formation of so-called tri-phase interface of the electrode, the fuel and the electrolyte can be surely and fully achieved. Thus, the electrode characteristics can be improved. In the electrode for the fuel cell according to the aspect of the present invention, a configuration may be employed, in which the proton conductor is an ion exchange resin. Having such configuration, sufficient proton conductivity can be surely provided.

In the electrode for the fuel cell according to the aspect of the present invention, a configuration may be employed, in which at least a part of the metal fiber sheet is hydrophobic treated. Having such configuration, a hydrophobic region can be formed on the metal fiber sheet that has a hydrophilic surface. Therefore, drain of moisture from the metal fiber sheet is accelerated. Thus, flooding is inhibited to enhance the output power of the fuel cell. In particular, water generated by the electrochemical reaction can be drained with higher efficiency by employing it as an oxidant electrode, thereby ensuring the permeating paths for gas.

According to another aspect of the present invention, there is provided a fuel cell, comprising a fuel electrode, an oxidant electrode, and a solid electrolyte membrane sandwiched between the fuel electrode and the oxidant electrode, wherein at least one of the fuel electrode or the oxidant electrode is the electrode for the fuel cell according to any one of the above-described configurations.

The fuel cell according to the present invention comprises the electrode for the fuel cell having the above-described configuration. Thus, higher level of the output power can be stably provided. In addition, since it is not necessary to employ a power collection member, the configuration and the manufacturing process can be simplified, and reduction in the size and the weight and reduction in the thickness thereof can be achieved.

In the fuel cell according to the aspect of the present invention, a configuration may be employed, in which a power collection member is not provided. Having this configuration, and reduction in the size, the thickness and the weight of the fuel cell can be achieved, and moreover, contact resistances among the members composing the electrode can be reduced. For example, the electrode for the fuel cell may compose the fuel electrode, and a fuel may be directly supplied on the surface of the electrode for the fuel cell. The situation that the fuel is directly supplied on the surface of the electrode for the fuel cell indicates a situation that the fuel is supplied to the fuel electrode without using a power collection member such as an end plate. The specific configuration that the fuel is directly supplied may include, for example, a configuration of providing a fuel container or a fuel supply portion in contact with the porous metal sheet of the fuel electrode. Here, when the porous metal sheet is plate-shaped, appropriately, through holes, stripe-shaped introduction paths or the like may be provided on the surface thereof. Having such configuration, the fuel can be supplied to the entire electrode from the surface of the metal fiber sheet with higher efficiency.

In addition, in the fuel cell according to the aspect of the present invention, a configuration may be employed, in which the electrode for the fuel cell composes the oxidant electrode, and an oxidant is directly supplied on the surface of the electrode for the fuel cell. The situation that the oxidant is directly supplied indicates a situation that the oxidant such as air, oxygen or the like is directly supplied on the surface of the oxidant electrode without using an end plate or the like.

As have been described above, according to the present invention, the reduction in size and the weight of the fuel cell can be achieved by employing the metal fiber sheet as the electrode base member. In addition, according to the present invention, output characteristics of the fuel cell can be improved. Further, according to the present invention, the process for manufacturing the fuel cell can be simplified.

### BRIEF DESCRIPTION OF THE DRAWINGS

The above and other objects, features and advantages of the present invention will be more apparent from the following description taken in conjunction with the accompanying drawings.

FIG. 1 is a diagram, schematically showing a structure of a metal fiber sheet in the present embodiment.

FIG. 2 is a diagram, showing a configuration of an apparatus for manufacturing metal fibers.

FIG. 3 is a diagram, showing a cross section along line F3-F3 in the apparatus for manufacturing metal fibers of FIG. 2.

FIG. 4 is a cross-sectional view, schematically showing configurations of a fuel electrode and a solid electrolyte membrane of the fuel cell.

FIG. 5 is a cross-sectional view, schematically showing a single cell structure of the fuel cell according to the present embodiment.

FIG. 6 is a cross-sectional view, schematically showing configurations of the fuel electrode and the solid electrolyte membrane in the fuel cell of FIG. 5.

FIG. 7 is a cross-sectional view, schematically showing configurations of the fuel electrode and the solid electrolyte membrane of the conventional fuel cell.

FIG. 8 is a diagram, showing a configuration of the fuel cell according to the present embodiment.

### DETAILED DESCRIPTION OF THE INVENTION

The present invention relates to a fuel cell that employs a metal fiber sheet. Hereinafter, preferable Embodiments will be described in reference to the annexed drawings.

(Metal Fiber Sheet and Process for Manufacturing Thereof)

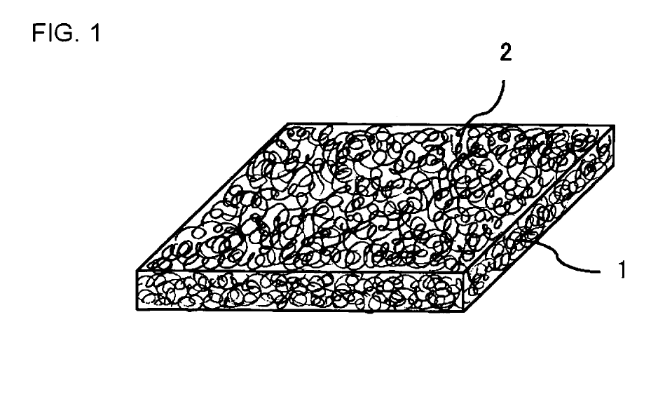

FIG. 1 is a diagram, showing a configuration of a metal fiber sheet 1 according to the present embodiment. The metal fiber sheet 1 is, as shown in FIG. 1, compressively formed so that metal fibers 2 are mutually entangled, to provide a porous plate. While the rectangular metal fiber sheet 1 is drawn in FIG. 1, geometry of the metal fiber sheet 1 is not limited to a rectangle, and it can be formed to a desired geometry by a method described later.

Line size p of the metal fiber 2 composing the metal fiber sheet 1 may be not less than 10 μm and not more than 100 μm. By taking the line size as equal to or larger than 10 μm, sufficient strength of the metal fiber 2 can be suitably ensured. Further, by taking the line size as equal to or smaller than 100 μm, processibility in a case of processing thereof into the metal fiber sheet 1 can be suitably ensured, and further, the metal fiber sheet 1 having suitable micro openings can be formed. Preferably, φ of metal fiber 2 may be not less than 30 μm and not more than 80 μm. Having such condition, the metal fiber sheet 1 made of the metal fibers 2 can be applied to the fuel cell as the material that suitably ensures transfer paths for all of electron, fuel, and water.

Here, methods for calculating the line size may include, for example, a method of calculating an average value of longer diameters (R) for ten points in the section thereof to obtain an average line size.

The metal fiber sheet 1 is a sheet obtained by forming one or more metal fiber fibers to a sheet-shaped product, and it may be a woven cloth, or may be non-woven sheet. It may be configured of one type of metal fibers 2, or mixture of two or more metal fibers 2 may be employed. Further, a mixture of materials other than the metal fiber may be formed.

The metal fiber 2 comprises an alloy containing Fe, Cr, and al least a metal of Si or Al as constituent elements. Content of Cr in the alloy is equal to or higher than 5% wt. and equal to or lower than 30% wt., and sum of contents of Si and Al in the alloy is equal to or higher than 3% wt. and equal to or lower than 10% wt. The rest thereof is composed of Fe, various types of additional elements and unavoidable impurities. Having such composition, sufficient strength, acid resistance and electroconductivity for applying thereof to the fuel cell can be obtained.

As described above, the content of Cr in the alloy is not lower than 5% wt. and not higher than 30% wt. When the content of Cr is lower than 5% wt., sufficient acid resistance for applying thereof to the fuel cell can not be obtained. On the other hand, when the content of Cr is higher than 30% wt., the fiber becomes fragile, and thus sufficient strength for applying thereof to the fuel cell cannot be obtained.

Besides, combined content of Si and Al in the alloy is not lower than 3% wt. and not higher than 10% wt. Having such condition, strength, acid resistance and durability of the metal fiber sheet 1 can be considerably improved.

In addition, Ni of 3 to 30% wt. may be included in the metal fiber 2. Having such condition, strength and durability of the metal fiber sheet 1 can be further improved.

Here, since the metal fiber sheet 1 has characteristics of having improved strength and durability as described above, it is not necessary to provide a separate carbon layer between the electrode and it. In addition, the metal fiber sheet 1 has higher conductivity one or more orders of magnitude than that of a carbon material with respect to an electric resistance. Furthermore, since the metal fiber sheet has micro openings, better diffusion-property for gas such as the fuel including methanol, air or the like is provided. Therefore, the metal fiber sheet 1 can serve a combined function of the gas-diffusion layer and the power collection electrode.

Although the thickness of the metal fiber sheet 1 is not particularly limited, it may be, for example, equal to or less than 1 mm when it is employed as the electrode for the fuel cell. The thickness of equal to or smaller than 1 mm can provide the reduction in the thickness, the size and the weight of the fuel cell. Moreover, further reduction in the size and the weight can be achieved by providing the thickness of equal to or smaller than 0.5 mm, and thus this can be more suitably employed for mobile devices. For example, the thickness may be equal to or smaller than 0.1 mm.

In addition, void width of the metal fiber sheet 1 may be, for example, equal to or lower than 1 mm. Having such dimension, better diffusion of fuel liquids and fuel gases can be ensured when it is employed as the electrode for the fuel cell.

Further, the porosity of the metal fiber sheet 1 may be, for example, within a range of from 20% to 80%. Better diffusion of the fuel liquid and the fuel gas can be maintained by having a value thereof as equal to or higher than 20%. Besides, better power collecting effect can be maintained by having a value thereof as equal to or lower than 80%. Moreover, the porosity of the metal fiber sheet 1 may be, for example, within a range of from 30% to 60%. Having such condition, better diffusion of the fuel liquid and the fuel gas can be further maintained and better power collecting effect can be maintained. Here, the porosity can be calculated from, for example weight and volume of the metal fiber sheet 1, and specific gravity of the fiber.

Next, the method for manufacturing for the metal fibers 2 and the metal fiber sheet 1 employing thereof will be described in detail.

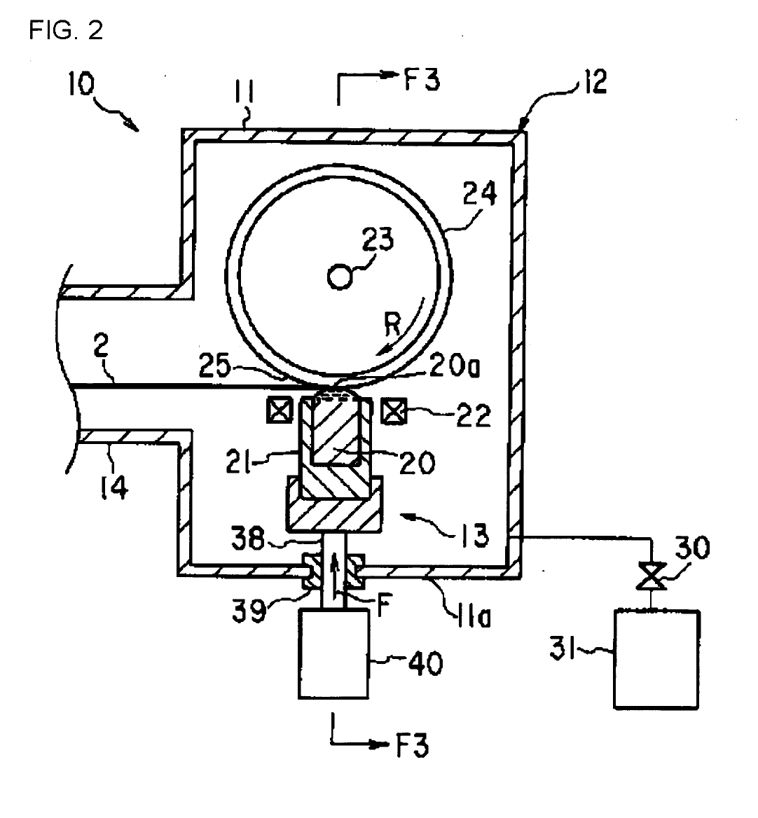

Although the method for manufacturing the metal fibers 2 is not particularly limited, they can be manufactured by employing an apparatus 10 for manufacturing the metal fibers having a configuration shown in FIG. 2 with higher efficiency, for example. The configuration of the apparatus 10 for manufacturing metal fibers comprises an apparatus main body 12 having a chamber 11 that is capable of being sealed, a material supplying mechanism 13 attached to the apparatus main body 12 and a fiber recovering section 14 and the like.

A cylindrical holder 21, a high frequency induction coil 22, a cooler (not shown in the drawings), and a disc 24 and the like are provided in an interior of a chamber 11 that composes a housing of the apparatus main body 12. The holder 21 functions as a measure for holding a material that substantially-vertically holds a rod-shaped metal source material 20. The high frequency induction coil 22 functions as a measure for heating that forms molten metal 20a by melting an upper end portion of the metal source material 20. A water-cooling jacket or the like is employed for the cooler (not shown in the drawings), for example. In addition, the disc 24 is configured to be driven to rotate along a certain direction (direction shown by an arrow R in FIG. 2) around a shaft 23 that extends toward a horizontal direction.

The disc 24 is composed of a metal having high thermal conductivity such as, for example, copper or copper alloy, or a refractory material such as molybdenum, tungsten and the like, and has a rim 25 that is contacted with the molten metal 20a from the upward. The diameter of the disc 24 may be, for example, 20 cm. As shown in FIG. 2, the rim 25 forms a perfect circle in viewing the disc 24 from the front face direction.

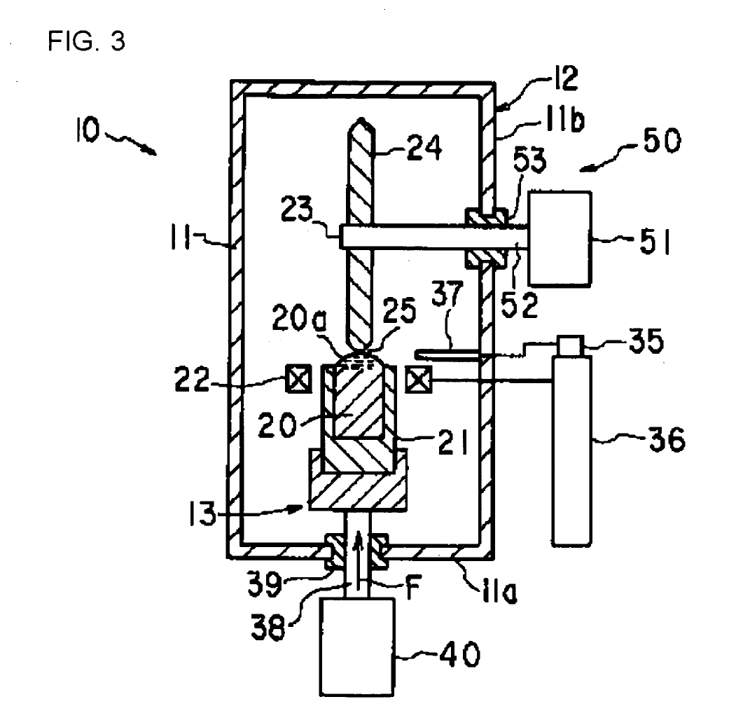

FIG. 3 is a diagram, showing a cross section along line F3-F3 direction of the apparatus for manufacturing metal fibers of FIG. 2. As shown in FIG. 3, the rim 25 of the disc 24 forms a v-shaped sharply peaked edge over all laps of the disc 24 in viewing the disc 24 from the side surface direction.

In addition, an exhaust mechanism that comprises an opening/closing valve 30 and a vacuum pump and the like, or a non-oxidizing atmosphere generator 31 such as an inert gas supplying mechanism is attached to the chamber 11. These can maintain a vacuum atmosphere (precisely reduced pressure atmosphere) or a non-oxidizing atmosphere such as an inert gas in the interior of the chamber 11.

The high frequency induction coil 22 is provided at a location for surrounding the upper end portion of the metal source material 20 that is supported by the holder 21. The high frequency induction coil 22 is coupled to a high frequency generator 36 through a current control unit 35 shown in FIG. 3. In addition, a radiation thermometer 37 for detecting a temperature of the molten metal 20a by a non-contacting method is provided. The radiation thermometer 37 is electrically coupled to the high frequency generator 36 through the current control unit 35. Here, it is preferable that the upper end of the high frequency induction coil 22 is spaced apart by a distance of equal to or wider than 10 mm from the disc 24. Having such configuration, influence in the disc 24 due to the high-frequency heating can be prevented.

Material of the holder 21 may be a heat resisting material such as a ceramic, for example. The holder 21 functions as a stopper for a motion so that the metal source material 20 having a straight rod-shape and a circular cross section does not move toward the transverse direction (radial direction). The inside diameter of the holder 21 may be equal to or smaller than φ 10 mm so that vibration of an exposed portion of the metal source material 20 can be suppressed, and the distance between the upper end of the holder 21 and the disc 24 may be preferably equal to or smaller than 5 mm. A rod-shaped pushing-up member 38 is provided under the holder 21. In addition, a sealing portion 39 is provided for tightly sealing a penetrating part of the pushing-up member 38 through the bottom wall 11a of the chamber 11.

The material supplying mechanism 13 is so configured that the metal source material 20 would be pushed up toward the rim 25 of the disc 24 at a desired speed by an actuator 40 such as a cylinder mechanism. In addition, a linear motion mechanism comprising a combination of an electric motor, ball screws, a linearly moving-guide member and the like may be adopted for the actuator 40, instead of a cylinder mechanism that employs a pressure of a fluid. Resolution of the cylinder mechanism may be, for example, equal to or higher than ⅙ mms⁻¹.

In addition, as shown in FIG. 3, a rotary driving mechanism 50 is provided in chamber 11 for rotating the disc 24 at higher speed. The rotary driving mechanism 50 comprises, for example, a motor 51 provided outside of the chamber 11, an axis of rotation 52 driven by the motor 51 and a sealing portion 53 that tightly seals a penetrating portion of the axis of rotation 52 through the side wall 11b of the chamber 11. The sealing portion 53 may be, for example, a magnetic fluid sealing employing a magnetic fluid.

The motor 51 rotates the disc 24 at a rate on the order of several thousand rounds per minute, for example to provide a contact of the rim 25 of the disc 24 with the molten metal 20a, so that the molten metal 20a is partially flown to a tangent direction of the disc 24 and is then quenched to form the metal fiber 2.

In the apparatus 10 for manufacturing the metal fibers having the above-described configuration, at least the holder 21, the high frequency induction coil 22 and the disc 24 are housed within the chamber 11. Then, the manufacturing of the metal fibers 2 is conducted within an inert gas atmosphere to provide an efficient cooling of the metal fibers 2 when the melted metal source material 20 is formed to provide the fibers. In this occasion, the interior of the chamber 11 is evacuated (for instance, 10⁻³ to 10⁻⁴ Torr) for preventing oxidation of the metal source material 20 and the metal fibers 2, and thereafter, an inert gas such as Ar is introduced in the chamber 11.

Next, effects of the above-described apparatus 10 for manufacturing the metal fibers will be described. The disc 24 is rotated at a predetermined peripheral velocity of, for example, a peripheral velocity of 20 m/s by the rotary driving mechanism 50. The linear rod-shaped metal source material 20 having an outer diameter of, for example, φ 6 mm, supported by the holder 21, is gradually pushed up toward the disc 24 by the material supplying mechanism 13 at a rate of around 0.5 mm/s, for example, an eventually, the upper end portion of the metal source material 20 moves to the position of the high frequency induction coil 22. The upper end portion of the metal source material 20 is heated by the high frequency induction coil 22 to form the molten metal 20a on the upper end of the metal source material 20. Then, the metal source material 20 is moved toward the rim 25 of the disc 24 at a predetermined rate, on the order of 0.5 mm/s, for example, using the material supplying mechanism 13. The material supply rate in this time is set depending upon a rotation peripheral velocity of the disc 24 or the like, such that the metal fiber 2 to be manufactured have desired line size.

The temperature of the molten metal 20a is detected on a steady basis by the radiation thermometer 37, and the temperature detecting signal of the molten metal 20a is fed back to the high frequency generator 36 to control an output power of the high frequency generator 36, thereby maintaining the temperature of the molten metal 20a at a constant level.

The molten metal 20a contacted with the rim 25 of disc 24 having the sharp edge is continually flown toward the direction of the tangent of the disc 24 as a form of, for example, a metal fiber 2 having a line size of 20 μm to 100 μm, while being quenched by the rotation of the disc 24 to be solidified, and then is introduced into the fiber recovering section 14. Then, the material supplying mechanism 13 gradually pushes up the metal source material 20 corresponding to a decrease in the amount of the molten metal 20a, to control the actuator 40, so that the contact condition of the rim 25 of the disc 24 with molten metal 20a is constant at any time.

Here, a rate of pushing up the metal source material 20 depends on the relationship with the rotational velocity of the disc 24, and when the rotation peripheral velocity of the disc 24 is, for example, on the order of 20 m/s, it is desirable to provide the pushing-up rate of equal to or lower than 1 mm/s. Having such condition, scattering can be avoided when the molten metal 20a contacts with the disc 24, and thus the fiber can be surely formed.

The metal fibers 2 are obtained as described above. Cross section of the obtained metal fiber 2 is nearly a circle, and changes to a certain extent depending on the conditions of the disc 24 and the molten metal 20a. As such, the apparatus 10 for manufacturing metal fibers can be employed to manufacture the metal fiber 2 that has a desired line size of, for example, equal to or lower than 100 μm with better efficiency. Since no drawing processing is performed in the method employing the apparatus 10 for manufacturing metal fibers, the metal fiber 2 can be obtained without being affected by ductility or a toughness of the material or a processibility.

Here, the manufacturing method for the metal fiber 2 is not limited to the manufacturing methods described above, and the metal fiber 2 can also be manufactured by, for example, melt spinning method such as melt extrusion method, in-rotating-liquid-spinning method, jet quenching method, Taylor method and the like, cutting method such as turning method, wire saving method, chatter vibration cutting method and the like, whisker or coating method. Drawing method such as single line drawing method, bundle drawing method and the like may also be employed, though the number of processing steps and the number of the heat treatment are increased.

Next, the method for manufacturing the metal fiber sheet 1 by using the obtained metal fiber 2 will be described. The metal fiber sheet 1 can be obtained by accumulating the metal fibers 2 that have been cut off with predetermined lengths to form a floc, and then compressively forming the floc as required. As such method, for example, a method of forming a floc web from the metal fibers 2, or in other words, non-woven fabric-like bulk of the metal fibers, and then plying dozens of these bulks and compressively sintering thereof, or a method employing a needle punching processing that involves compressing the floc web by using needles, may be employed.

### First Embodiment

The present embodiment relates to a fuel cell that employs the metal fiber sheet 1 obtained by the above-mentioned method.

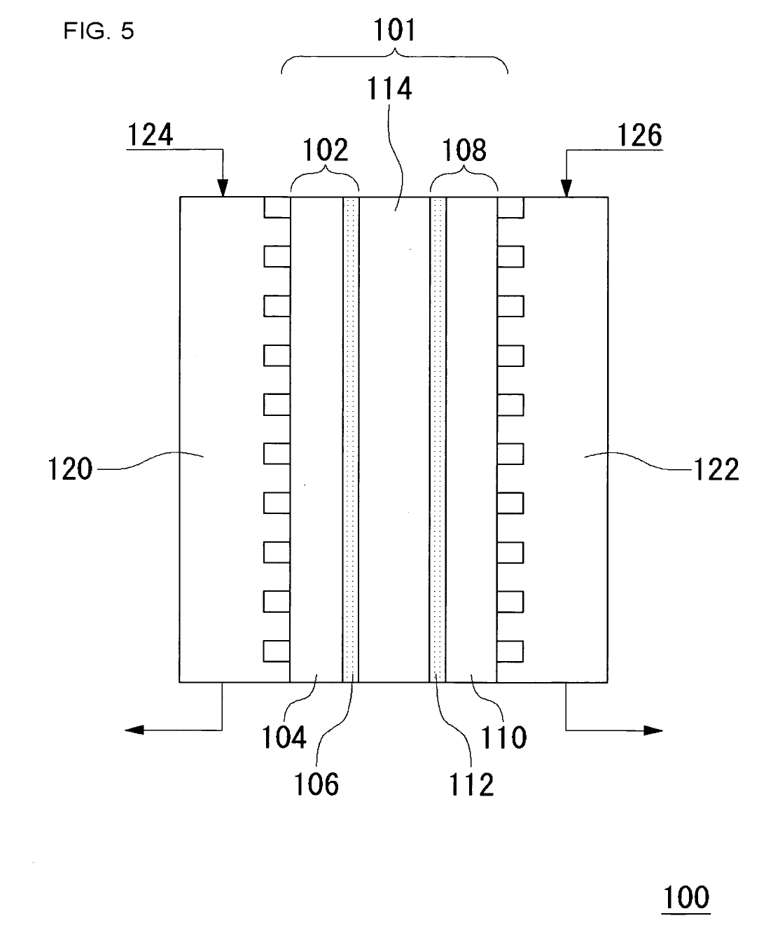

FIG. 5 is a cross-sectional view, schematically showing a single cell structure of the fuel cell according to the present embodiment. While the configuration of the fuel cell 100 having a singular single cell structure 101 is shown in FIG. 5, a plurality of single cell structures 101 may be provided. Each single cell structure 101 is composed of a fuel electrode 102, an oxidant electrode 108 and a solid electrolyte membrane 114. The single cell structures 101 are electrically coupled via fuel electrode side separators 120 and the oxidant electrode side separators 122 to form the fuel cell 100.

The fuel electrode 102 and the oxidant electrode 108 are formed by providing a catalyst layer 106 and a catalyst layer 112 on a base member 104 and a base member 110, respectively. The catalyst layer 106 and the catalyst layer 112 may include, for example, carbon particles supporting catalyst and fine particles of a solid polymer electrolyte.

The aforementioned metal fiber sheet 1 is employed for the base member 104 and the base member 110. In this occasion, it is preferable to use the metal fiber sheet 1 composed of the metal fibers 2 having line size p of equal to or smaller than 80 μm. The metal fiber sheet 1 has an electric resistance that is one order of magnitude less than carbon materials such as conventionally used carbon paper, and has better electroconductivity. Here, the base member 104 and the base member 110 may be made of the metal fiber sheet 1 of the same composition, or of different compositions.

The illustrative catalysts for the fuel electrode 102 includes platinum, rhodium, palladium, iridium, osmium, ruthenium, rhenium, gold, silver, nickel, cobalt, lithium, lanthanum, strontium, yttrium and the like, and one of these may be employed alone or a combination of two or more of these may also be employed. On the other hand, same catalyst as employed for the catalyst for the fuel electrode 102 may also be employed for the catalyst for the oxidant electrode 108, and the above-described illustrative materials may be used. Here, same catalyst may be employed for or different catalysts may be employed for the catalysts for the fuel electrode 102 and the oxidant electrode 108.

The illustrative carbon particles supporting the catalyst may include acetylene black (“DENKA BLACK”, registered trademark, commercially available from DENKI KAGAKU KOGYO KABUSHIKI KAISHA, Tokyo Japan; “XC72”, commercially available from Vulcan Materials Company, Birmingham, Ala., USA or the like), Ketjenblack, amorphous carbon, carbon nanotube, carbon nanohorn and the like. The particle size of the carbon particles may be for example, within a range of from 0.01 μm to 0.1 μm, and preferably within a range of from 0.02 μm to 0.06 μm.

The solid polymer electrolyte, which is a constituent of the catalyst electrode of the present embodiment, functions as providing electrically couplings between the carbon particles supporting the catalyst and the solid electrolyte membrane 114 on the surface of the catalyst electrode and as transferring the organic liquid fuel to the catalyst surface, and requires a proton conductivity, and further, a permeability for the organic liquid fuel such as methanol is required for the fuel electrode 102, and a permeability for oxygen is required for the oxidant electrode 108. In order to satisfy such a requirements for the solid polymer electrolyte, materials having better proton conductivity and better permeability for the organic liquid fuel such as methanol may be preferably employed. More specifically, an organic polymer containing polar group including strong acid group such as sulfonic group, phosphate group and the like, and weak acid group such as carboxyl group and the like may be preferably employed. As the example of such organic polymer may be, more specifically, fluorine-containing polymer having fluorine resin backbone and proton acid group may be employed. In addition, polyetherketone, polyetheretherketone, polyethersulfone, polyetherethersulfone, polysulfone, polysulfide, polyphenylene, polyphenylene oxide, polystyrene, polyimide, polybenzimidazole, polyamide or the like may be employed. In addition, in view of reducing crossover of the liquid fuel such as methanol, hydrocarbon material containing no fluorine may be employed as such polymer. Further, polymer containing aromatic compound may also be employed as polymer for the base member.

In addition, as polymers for the target base member that is bound with proton acid group, resins containing nitrogen or hydroxy group, including polybenzimidazole derivatives, polybenzoxazole derivatives, polyethylenimine cross linking polymer, polysilamine derivatives, amine-substituted polystyrenes such as polydiethylaminoethylstyrene and the like, nitrogen-substituted polyacrylates such as polydiethylaminoethylmethacrylate and the like; hydroxy group-containing polyacrylic resin represented by silanol-containing polysiloxane and polyhydroxyethylmethacrylate; hydroxy group-containing polystyrene resins represented by poly (p-hydroxystyrene); may also be employed.

In addition, compounds that contain with a substitutional group having cross linking nature, such as, for example, vinyl group, epoxy group, acrylic group, methacrylic group, cinnamoyl group, methylol group, azido group and naphthoquinone diazido group, may be appropriately employed for polymers exemplified above. In addition, compounds containing these groups as cross linked thereto may also be employed.

More specifically, as a first solid polymer electrolyte 150 or a second solid polymer electrolyte 151, polymers including, for example,
sulfonated polyetherketone;
sulfonated polyetheretherketone;
sulfonated polyethersulfone;
sulfonated polyetherethersulfone;
sulfonated polysulfone;
sulfonated polysulfide;
sulfonated polyphenylene;
aromatic compound-containing polymer such as sulfonated poly (4-phenoxybenzoyl-1,4-phenylene), alkyl sulfonated polybenzimidazole and the like;
sulfo-alkylated polyetheretherketone;
sulfo-alkylated polyethersulfone;
sulfo-alkylated polyetherethersulfone;
sulfo-alkylated polysulfone;
sulfo-alkylated polysulfide;
sulfo-alkylated polyphenylene;
sulfonate group-containing perfluorocarbon (Nafion (registered trademark, commercially available from E.I. du Pont de Nemours & Company Inc., Wilmington, Del., USA), Aciplex (commercially available from Asahi Kasei Corporation, Osaka, Japan) or the like);
carboxyl group-containing perfluorocarbon (Flemion S-membrane (registered trademark, commercially available from Asahi Glass Co., Ltd., Tokyo Japan or the like);
copolymers such as polystyrenesulfonate copolymer, polyvinyl sulfonic acid copolymer, fluorine-containing polymers containing cross linking alkyl sulfonic acid derivative, fluorine resin backbone and sulfonic acid;
copolymer obtainable by copolymerizing acrylamides such as acrylamide-2-methylpropanesulfonic acid and acrylates such as n-butylmethacrylate;
   may be employed. In addition, aromatic polyetheretherketone or aromatic polyetherketone may also be employed.

Among these, in view of ionic conductivity, sulfonate group-containing perfluorocarbon (Nafion (registered trademark, commercially available from E.I. du Pont de Nemours & Company Inc., Wilmington, Del., USA), Aciplex (commercially available from Asahi Kasei Corporation, Osaka, Japan) or the like), carboxyl group-containing perfluorocarbon (Flemion S-membrane (registered trademark, commercially available from Asahi Glass Co., Ltd., Tokyo Japan, or the like) and the like may be preferably employed.

The above described solid polymer electrolytes for the fuel electrode 102 and the oxidant electrode 108 may be same or may be different.

The solid electrolyte membrane 114 functions as separating the fuel electrode 102 from the oxidant electrode 108 and as transferring hydrogen ion therebetween. Thus, it is preferable to employ a membrane having higher proton conductivity for the solid electrolyte membrane 114. It is also preferable to be chemically stable and have higher mechanical strength.

As materials composing the solid electrolyte membrane 114, compounds containing proton acid group such as, for example, sulfonic group, sulfoalkyl group, phosphate group, phosphonate group, phosphine group, carboxyl group, sulfone imide group and the like, maybe employed. As polymers for the target base member that is bound with proton acid group, membranes of polyetherketone, polyetheretherketone, polyethersulfone, polyetherethersulfone, polysulfone, polysulfide, polyphenylene, polyphenyleneoxide, polystyrene, polyimide, polybenzimidazole, polyamide or the like, may be employed. In addition, in view of reducing crossover of the liquid fuel such as methanol, hydrocarbon material containing no fluorine may be employed as such polymer. Further, polymer containing aromatic compound may also be employed as polymer for the base member.

In addition, as polymers for the target base member that is bound with proton acid group, resins containing nitrogen or hydroxy group, including polybenzimidazole derivatives, polybenzoxazole derivatives, polyethylenimine cross linking polymer, polysilamine derivatives, amine-substituted polystyrenes such as polydiethylaminoethylstyrene and the like, nitrogen-substituted polyacrylates such as polydiethylaminoethylmethacrylate and the like;

hydroxy group-containing polyacrylic resin represented by silanol-containing polysiloxane and polyhydroxyethylmethacrylate; hydroxy group-containing polystyrene resins represented by poly (p-hydroxystyrene); may also be employed.

In addition, compounds that contain with a substitutional group having cross linking nature, such as, for example, vinyl group, epoxy group, acrylic group, methacrylic group, cinnamoyl group, methylol group, azido group and naphthoquinone diazido group, may be appropriately employed for polymers described above. In addition, compounds containing these groups as cross linked thereto may also be employed.

More specifically, as the solid electrolyte membrane 114, polymers including, for example,
sulfonated polyetheretherketone;
sulfonated polyethersulfone;
sulfonated polyetherethersulfone;
sulfonated polysulfone;
sulfonated polysulfide;
sulfonated polyphenylene;
aromatic compound-containing polymer such as sulfonated poly (4-phenoxybenzoyl-1,4-phenylene), alkyl sulfonated poly benzimidazole and the like;
sulfo-alkylated polyetheretherketone;
sulfo-alkylated polyethersulfone;
sulfo-alkylated polyetherethersulfone;
sulfo-alkylated polysulfone;
sulfo-alkylated polysulfide;
sulfo-alkylated polyphenylene;
sulfonate group-containing perfluorocarbon (Nafion (registered trademark, commercially available from E.I. du Pont de Nemours & Company Inc., Wilmington, Del., USA), Aciplex (commercially available from Asahi Kasei Corporation, Osaka, Japan) or the like);
carboxyl group-containing perfluorocarbon (Flemion S-membrane (registered trademark, commercially available from Asahi Glass Co., Ltd., Tokyo Japan or the like);
copolymers such as polystyrenesulfonate copolymer, polyvinyl sulfonic acid copolymer, fluorine-containing polymers containing cross linking alkyl sulfonic acid derivative, fluorine resin backbone and sulfonic acid;
copolymer obtainable by copolymerizing acrylamides such as acrylamide-2-methylpropanesulfonic acid and acrylates such as n-butylmethacrylate;
   may be employed. In addition, aromatic polyetheretherketone or aromatic polyetherketone may also be employed.

Here, in the present embodiment, in view of inhibiting crossover, it is preferable to employ materials having lower permeability for the organic liquid fuel for both the solid electrolyte membrane 114 and the first solid polymer electrolyte 150 or the second solid polymer electrolyte 151. For example, it is preferable to compose of condensation-type aromatic compound-containing polymers such as sulfonated poly (4-phenoxy benzoyl-1,4-phenylene), alkyl sulfonated polybenzimidazole and the like. In addition, it is preferable that the solid electrolyte membrane 114 and the second solid polymer electrolyte 151 have degree of swelling with methanol of, for example, equal to or lower than 50%, and more preferably equal to or lower than 20% (degree of swelling for 70% vol. of MeOH aqueous solution). Having such configuration, particularly improved interface adhesiveness and proton conductivity are obtained.

In addition, the fuel 124 employed for the fuel cell 100 may include a liquid fuel such as, for example, methanol and the like, and this may be directly supplied thereto. Hydrogen, for example, may also be employed. In addition, reformed hydrogen may also be employed by using natural gas, naphtha and the like as the fuel. In addition, as the oxidant 126, for example oxygen, air and the like may be employed.

Next, the method for manufacturing the electrode for the fuel cell and the fuel cell 100 according to the present embodiment is not particularly limited, and it can be manufactured as follows, for example.

The metal fiber sheet 1 is manufactured by the aforementioned method, and the sheet is cut to a predetermined dimension to obtain the base member 104 and the base member 110. Supports of catalyst onto carbon particles in the fuel electrode 102 and the oxidant electrode 108 can be performed by the generally employed impregnation method. Carbon particles supporting the catalyst and the solid polymer electrolyte are dispersed within the solvent to form a paste-like product, and then the obtained product is applied on the base member, and is dried to obtain the fuel electrode 102 and the oxidant electrode 108. Here, the particle size of the carbon particles may be, for example, within a range of from 0.01 μm to 0.1 μm. The particle size of the catalyst particles may be, for example, within a range of from 1 nm to 10 nm. In addition, the particle size of the solid polymer electrolyte particles maybe, for example, within a range of from 0.05 μm to 1 μm. The carbon particles and the solid polymer electrolyte particles are employed by a weight ratio within a range of, for example, from 2:1 to 40:1. In addition, the weight ratio of water and the solute in the paste may be, for example, on the order of 1:2 to 10:1.

While the available method for applying the paste onto the base member 104 and the base member 110 is not particularly limited, methods such as, for example, brush application, spraying application, screen printing and the like may be employed. The paste may be applied to a thickness within a range of, for example, from about 1 μm to 2 mm. After applying the paste, they are heated at a heating temperature and for a heating time that are defined corresponding to the type of the employed fluorine resin to manufacture the fuel electrode 102 or the oxidant electrode 108. The heating temperature and the heating time may be suitably selected depending on the employed material, and the heating temperature may be within a range of from 100 degree C. to 250 degree C., and the heating time may be within a range of from 30 seconds to 30 minutes.

The surface of the base member 104 or the base member 110 may be treated by a hydrophobic processing. In particular, concerning the oxidant electrode 108, it is preferable to form a hydrophobic region by a method of adhering a water-shedding material within an opening in the metal fiber 2 that composes the base member 110, and the like. Since the surface of the metal fiber 2 is hydrophilic, transfer paths for both gas and water can be suitably ensured by preparing the hydrophobic region within a part thereof. Thus, water generated by the electrode reaction at the oxidant electrode 108 can be drained with higher efficiency, and the supply of the oxidant 126 can be performed with higher efficiency.

The available method for treating the surface of the base member 104 or the base member 110 by the hydrophobic process may include a method, in which the base member 104 or the base member 110 is immersing within or contacting with a solution or a suspension of a hydrophobic substance such as, for example, polyethylene, paraffin, polydimethylsiloxane, polytetrafluoroethylene (PTFE), tetrafluoroethylene perfluoroalkylvinylether copolymer (PFA), fluoroethylenepropylene (FEP), poly (perfluorooctylethylacrylate) (FMA), polyphosphazene and the like, and then a water-shedding resin is adhered within the openings. In particular, the hydrophobic region can be suitably formed by employing materials having higher water-shedding property, such as polytetrafluoroethylene (PTFE), tetrafluoroethylene perfluoroalkylvinylether copolymer (PFA), fluoroethylenepropylene (FEP), Poly (perfluorooctylethylacrylate) (FMA), polyphosphazene and the like.

In addition, the hydrophobic materials such as PTFE, PFA, FEP, fluorinated pitch, polyphosphazene and the like may be crushed and a suspension of the crushed product may be prepared with a solvent, and then the suspension may be applied thereto. The applying solution may be a mixed suspension of a hydrophobic material and an electroconductive material such as metal, carbon and the like. In addition, the applying solution may also prepared by crushing an electroconductive fiber having a water-shedding property, for example, “Dreamalon” (commercially available from Nissen Co., LTD., Osaka, Japan, registered trademark) and the like, and preparing a suspension of the crushed product in a solvent. As such, the output power of the cell can be further increased by employing the material having electroconductivity and water-shedding property.

In addition, an electroconductive material such as metal or carbon may crushed, and then the crushed product may be coated with the above-described hydrophobic material, and then a suspension of the coated product may be prepared, and eventually the suspension may be applied. While the applying method is not particularly limited, method such as, for example, brush application, spraying application, and screen printing may be employed. By the quantity of application is adjusted, the hydrophobic region can be formed in a part of the base member 104 or the base member 110. In addition, if the application is performed only in one surface of the base member 104 or the base member 110, the base member 104 or the base member 110 having a hydrophilic surface and a hydrophobic surface can be obtained.

In addition, hydrophobic group may be introduced in the surface of the base member 104 or the base member 110 by a plasma technique. Having such operation, the thickness of the hydrophobic portion can be adjusted to provide a desired thickness. For example, CF4 plasma treatment can be performed over the surface of the base member 104 or the base member 110.

The solid electrolyte membrane 114 can be manufactured by adopting an appropriate method depending on the employed material. For example, when the solid electrolyte membrane 114 is composed of an organic polymer material, it can be obtained by casting a liquid containing dissolved or dispersed organic polymer material within a solvent on an peeling sheet such as polytetrafluoroethylene and the like and then drying the cast product.

The obtained solid electrolyte membrane is sandwiched by the fuel electrode 102 and the oxidant electrode 108, and then is hot-pressed to obtain a Membrane Electrode Assembly. In this occasion, it is prepared so that the surface provided with the catalyst of both electrodes is in contact with the solid electrolyte membrane. While the condition for the hot-pressing can be selected according to the material, when the solid electrolyte membrane and/or the solid polymer electrolyte of the electrode surface are composed of an organic polymer having a softening point and exhibiting a glass transition, the temperature may be selected to be higher than the softening temperature or the glass transition temperature of these polymers. More specifically, the condition may be, for example, at a temperature within a range of from 100 degree C. to 250 degree C., with a pressure within a range of from 1 kg/cm² to 100 kg/cm², and for a time within a range of from 10 seconds to 300 seconds. The obtained Membrane Electrode Assembly will form the single cell structure 101 shown in FIG. 5.

Since the fuel cell 100 according to the present embodiment is light weight and small and is capable of providing higher output level, it can be suitably employed as the fuel cell for the mobile devices such as the mobile phone.

### Second Embodiment

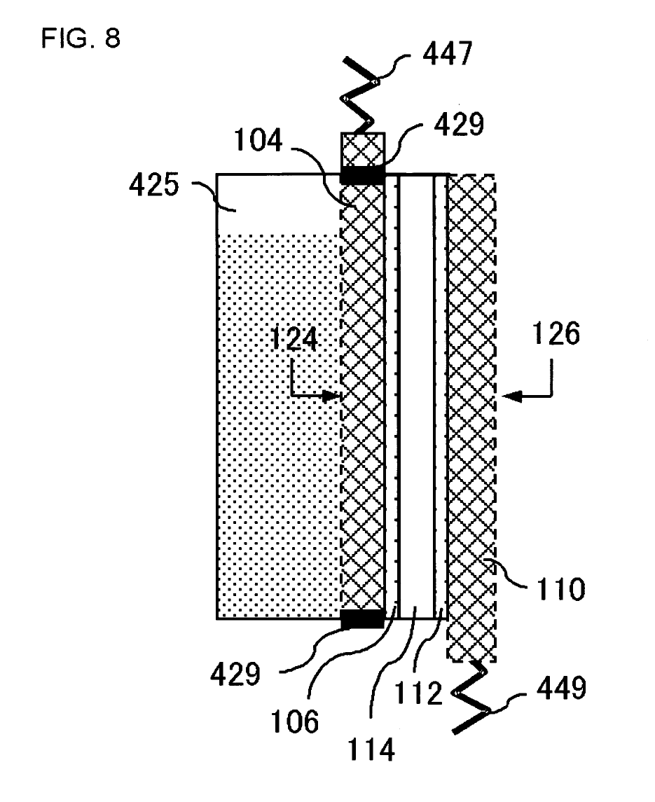

The present embodiment relates to a fuel cell having a configuration of employing the single cell structure 101 described in first embodiment, and being provided with no end plate. FIG. 8 is a diagram, showing a configuration of a fuel cell according to the present embodiment.

In the fuel cell of FIG. 8, the fuel electrode side separator 120 or the oxidant electrode side separator 122 are not employed, and the base member 104 and the base member 110 serves a combined function of a gas-diffusion layer and a power collection electrode. A fuel electrode side terminal 447 and an oxidant electrode side terminal 449 are provided for the base member 104 and the base member 110, respectively. Since the metal fiber sheet 1 having an electroconductivity that is one or more orders of magnitude less than the carbon materials for the base member 104 and the base member 110, power collection can be performed with higher efficiency without providing a bulk-metal power collection member.

Having such configuration, reduction in the size and the weight and reduction in the thickness of the fuel cell 100 can be achieved, and the manufacturing process thereof can be simplified. Further, since no contact resistance is generated between the base member 104 and the fuel electrode side separator 120 or between the base member 110 and the oxidant electrode side separator 122, output characteristics can also be improved. Here, in this case, the metal fiber 2 composing the metal fiber sheet 1 may be amorphous. A such amorphous material, an alloy composition containing an iron-group element such as Fe and Co prepared by a rapid solidification method and additionally containing a semimetal element such as B, C, P, Si and the like at 15% wt. to 30% wt., or a composition containing only metal elements prepared by a sputtering technique may be exemplified. Examples of the alloy prepared by the rapid solidification method may include Co—Nb—Ta—Zr containing alloy, Co—Ta—Zr containing alloy and the like. Having such configuration, strength and acid resistance of the metal fiber 2 can be further enhanced to prevent generation of a crack into material, thereby improving mechanical characteristics and durability of the metal fiber sheet 1.

In addition, since the base member 104 is bonded to the fuel container 425 in the fuel cell of FIG. 8, the fuel 124 is supplied to the base member 104 with higher efficiency from openings provided in the fuel container 425. The basemember 104 and the fuel container 425 may be bonded with an adhesive agent having a resistance to the fuel 124, or may be fixed by using bolts and nuts.

In the fuel cell of FIG. 8, the side surface circumference of the base member 104 is covered by a sealing material 429, thereby inhibiting leakage of the fuel 124. The use of the metal fiber sheet 1 for the material of the base member 104 eliminates the need for providing the power collection electrode, and a configuration for supplying the fuel 124 by directly contacting the fuel container 425 with the base member 104 composing the fuel electrode 102 is employed to obtain the thinner, smaller and lighter fuel cell.

In addition, the oxidant electrode may be directly contacted with an oxidant 126 such as air and oxygen without employing the end plate to achieve the supply thereof. Here, when a member such as a packaging member, which does not obstruct miniaturization, is employed for the base member 110 of the oxidant electrode 108, the oxidant 126 can be appropriately supplied via such member.

### Third Embodiment

The present embodiment relates to a fuel cell having a configuration, which is similar to that of the fuel cell 100 described in the first embodiment, except that the surfaces of the metal fibers 2 composing the base member 104 and the base member 110 are roughed, and that the catalyst is directly supported on the surfaces of the base member 104 and the base member 110 without interpositions of carbon particles.

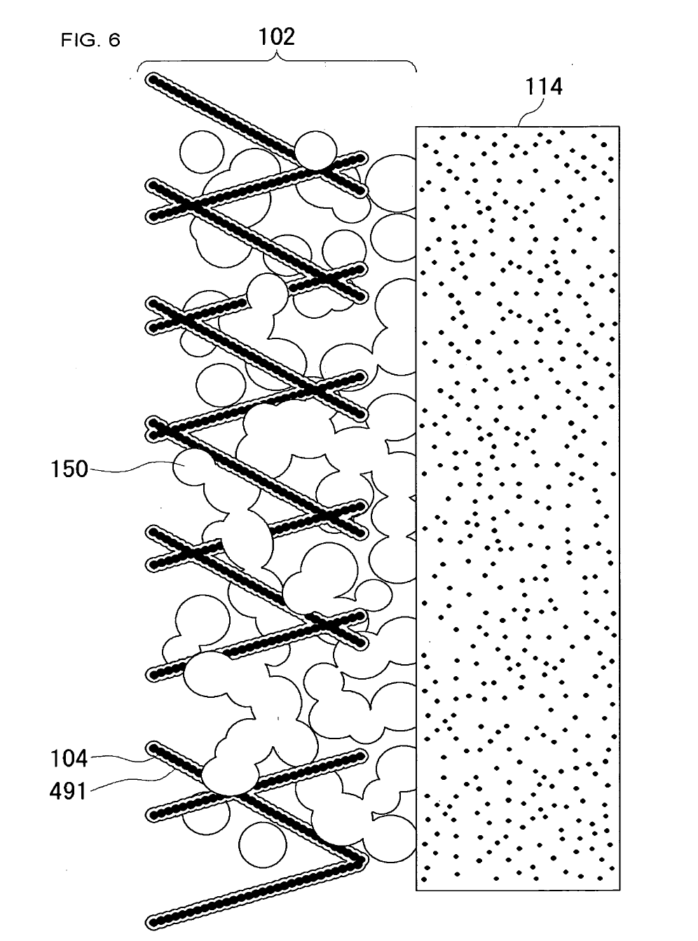

FIG. 6 is a cross-sectional view, schematically showing a fuel electrode 102 and a solid electrolyte membrane 114 of a single cell structure 101 that composes the fuel cell of FIG. 5. As illustrated, the fuel electrode 102 has a configuration, in which the surfaces of the metal fibers 2 composing the metal fiber sheet 1 that is base member 104 have concave and covexity structures, and catalysts 491 cover the surfaces thereof.

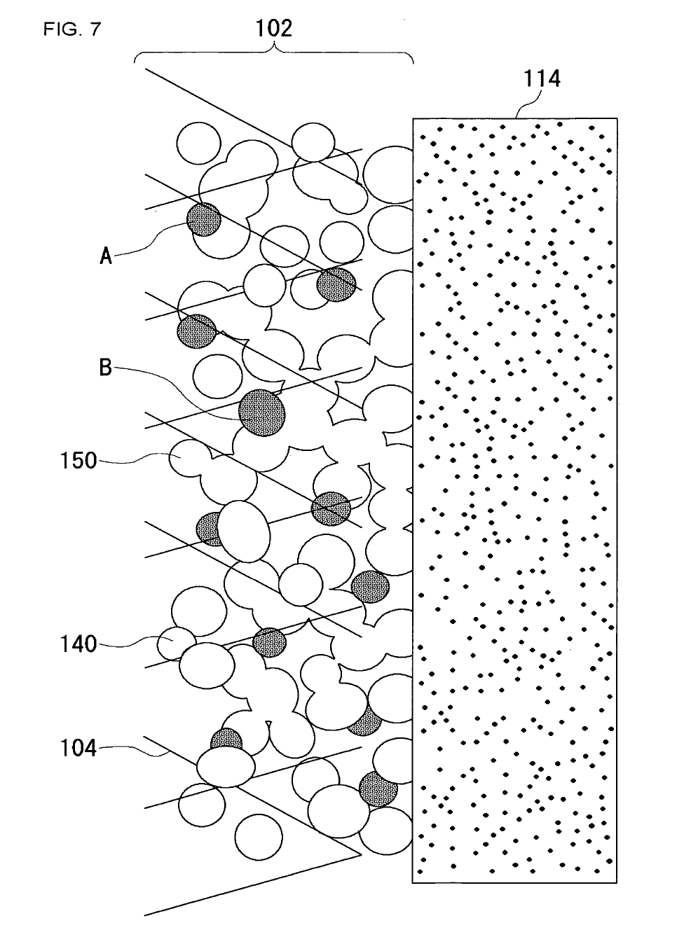

On the other hand, FIG. 7 is a cross-sectional view, schematically showing a configuration of the fuel electrode of the conventional fuel cell. Carbon material is employed as base member 104 in FIG. 7, and a catalyst layer comprising solid polymer electrolyte particles 150 and catalyst-supporting carbon particles 140 is formed on the surface thereof.

Feature of the fuel cell according to the present embodiment will be described as follows by illustrating the fuel electrode 102 and comparing FIG. 6 with FIG. 7. First of all, the metal fiber sheet 1 is employed for a base member of the fuel electrode 102 in FIG. 6. Since the metal fiber sheet 1 has better electroconductivity, in the fuel cell 100 it is not necessary to provide a power collection electrode of bulk metal or the like outside of the electrode, as described in the first embodiment. On the other hand, since a carbon material is employed for the base member 104 in FIG. 7, a power collection electrode is required.

In addition, the surfaces of the metal fibers 2 composing the base member 104 are roughed in FIG. 6. Thus, the surface area of the base member 104 is increased, thereby increasing a quantity of the catalyst that is capable of being supported thereon.

Thus, sufficient level of the surface area for supporting the sufficient amount of the catalyst 491 is ensured, and therefore, it is possible to support a certain amount of the catalyst 491 that is similar level to the case of employing the catalyst-supporting carbon particles 140 as in FIG. 7. Here, the surface of the base member 104 may be water-shedding processed.

In addition, since an electrochemical reaction in the fuel electrode 102 is caused at an interface with the catalyst 491, the solid polymer electrolyte particle 150 and the base member 104, as is so-called three-phase interface, it is critical to ensure the three-phase interface. Since the base member 104 is directly in contact with the catalyst 491 in FIG. 6, the contacting portion of the catalyst 491 with the solid polymer electrolyte particle 150 is necessarily a three-phase interface, and therefore transferring path for electron is ensured between the base member 104 and the catalyst 491.

On the other hand, particles having contacts with both the solid polymer electrolyte particle 150 and the base member 104 are effectively utilized among the catalyst-supporting carbon particles 140 in FIG. 7. Therefore, while electron generated on the surface of the catalyst (not shown in the drawings) that is supported by a catalyst-supporting carbon particle A is transferred from the catalyst-supporting carbon particle A through the base member 104 and eventually taken out to outside of the cell, for example, in the case of using particles that have no contact with base member 104, like a catalyst-supporting carbon particles B, even if electron is generated on the surface of the catalyst (not shown in the drawings) that is supported by the surface of the carbon particle, it can not be taken out to outside of the cell. In addition, concerning the catalyst-supporting carbon particle A, the contact resistance between the catalyst-supporting carbon particle 140 and the base member 104 is larger than the contact resistance between the catalyst 491 and the metal fiber sheet 1, and therefore it can be seen that the configuration shown in FIG. 6 provides more suitably ensuring the transfer path for electrons.

As such, by comparing FIG. 6 with FIG. 7, it is found that utilization efficiency and power collection efficiency of the catalyst 491 are improved by employing the configuration of FIG. 6. Thus, output characteristics of the single cell structure can be improved, and, in turn, cell characteristics of the fuel cell can be improved. In addition, since a process for providing the status that the catalyst is supported on the carbon can be omitted, the cell configuration and the manufacturing thereof can be further simplified.

It is suitable that the catalyst 491 is supported on the surface of the base member 104. The whole of or a part of the base member 104 may be coated. It is preferable that the entire surface of the base member 104 is coated as shown in FIG. 6, since the corrosion of the base member 104 can be inhibited. When the catalyst 491 coats the surface of the base member 104, the thickness of the catalyst 491 is not particularly limited, and, for example, may be within a range of from 1 nm to 500 nm.

Since the fuel cell main body according to the present embodiment can be basically obtained similarly as in the first embodiment, the manufacturing process thereof will be described as follows only in the points that are different therefrom.

In the fuel cell main body according to the present embodiment, the surface of the metal fiber sheet 1 composing the base member 104 and the base member 110 is roughened, and concave and convexity structure is formed on the surface. Methods for forming the fine concave and convexity structure on the surface of the metal fiber sheet 1 may employ, for example, an etching process such as an electrochemical etching, a chemical etching and the like.

As the electrochemical etching, an electrolytic etching can be performed by utilizing an anode polarization. Then, the base member 104 and the base member 110 are immersed within an electrolytic solution, and applied with a DC voltage of around 1 V to 10 V, for example. An acid solution such as for example, hydrochloric acid, sulfuric acid, super saturated oxalic acid, phosphoric acid-chromic acid mixture and the like can be employed for the electrolytic solution.

On the other hand, when the chemical etching is performed, the base member 104 and the base member 110 are immersed within an corrosion solution containing an oxidant. As for the etchant solution, for example, nitric acid, nitric acid alcohol solution (nital), picric acid alcohol (picril), ferric chloride solution or the like may be employed.

Further, in the present embodiment, a metal for functioning as the catalyst 491 is supported on the surface of the base member 104 and the base member 110. As for the method for providing a condition of the catalyst 491 being supported thereon, for example, plating technique such as electroplating, non-electrolytic plating and the like, vapor deposition such as vacuum deposition, chemical vapor deposition (CVD) and the like may be employed.

When the electroplating is performed, the base member 104 and the base member 110 are immersed within an aqueous solution containing ion of the target catalyst metal, and applied with a DC voltage of around 1 V to 10 V, for example. For example, when plating is carried out with Pt, Pt (NH₃)₂(NO₂)₂, (NH₄)₂PtCl₆ or the like may be added to an acid solution containing sulfuric acid, sulfamic acid and ammonium phosphate, and the plating may be performed at a current density of 0.5 to 2 A/dm². Further, when plating is carried out with a plurality of metals, the plating can be carried out to provide a desired thickness and quantity, by suitably controlling the electrical voltage, within a concentration level that provides a situation that one metal is diffusion-controlling.

Further, when the non-electrolytic plating is performed, a reducing agent such as sodium hypophosphite, sodium boron hydride and the like is added as the reducing agent to an aqueous solution containing the target catalyst metal ion of, for example Ni, Co, Cu ions, and the base member 104 and the base member 110 are immersed therein and then heated to a temperature of around 90 degree C. to 100 degree C.

The solid polymer electrolyte is adhered onto the surface of the catalyst 491 by a method for immersing the obtained base member 104 and base member 110 within a solid polymer electrolytic solution, and thereafter, the obtained product is sandwiched by the fuel electrode 102 and the oxidant electrode 108, and then is hot-pressed to obtain a Membrane Electrode Assembly.

Here, since the base member 104 and the base member 110 have better corrosion resistance, it is not necessary to provide a coating on the surface of the base member 104 or the base member 110 with the catalyst 491. For example, a configuration that particle-shaped catalyst 491 may be adhered onto the surface of the base member 104 or the base member 110 may also be employed. Such catalyst electrode may be obtained by, for example, preparing a dispersion liquid of the catalyst 491 and the solid polymer electrolyte, and applying thereof on the surface of the base member 104 or the base member 110, similarly as in the first embodiment.

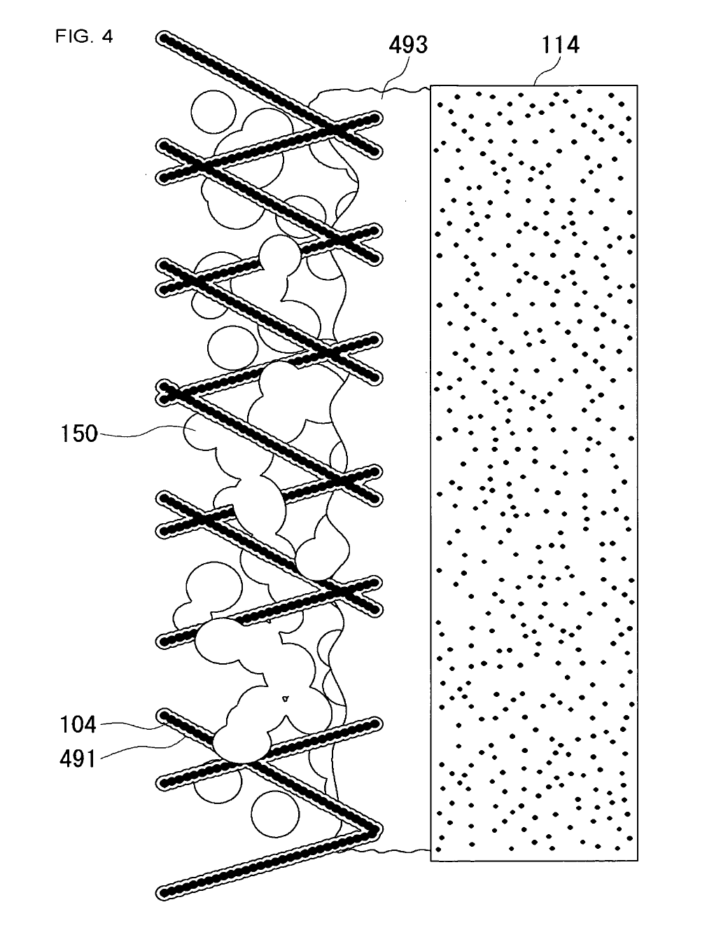

Further, in order to ensure the adhesiveness among the both electrodes and the solid electrolyte membrane 114, and to ensure a transfer path for hydrogen ion in the catalyst electrode, it is preferable that, a proton conductor layer is provided on the surfaces of the fuel electrode 102 and the oxidant electrode 108 to provide flatness to the surfaces. FIG. 4 is a cross-sectional view, schematically showing another configuration of the fuel electrode 102 and the solid electrolyte membrane 114. The configuration of FIG. 4 further comprises a planarizing layer 493 on the surface of the base member 104 in addition to the configuration of FIG. 6. The adhesiveness of the solid electrolyte membrane 114 with the base member 104 can be improved by providing the planarizing layer 493.

When the planarizing layer 493 is formed on the surface of the base member 104 and the base member 110, the planarizing layer 493 may be a proton conductor of an ion exchange resin or the like. Having such configuration, transfer paths for hydrogen ion can be suitably formed between the solid electrolyte membrane 114 and the catalyst electrode. The material of the planarizing layer 493 may be selected from, for example, the materials available for the solid electrolyte or the solid electrolyte membrane 114.

### Fourth Embodiment

The present embodiment relates to a fuel cell employing a metal fiber sheet 1, in which the porosity of one surface thereof is larger than the porosity of the other surface. As such metal fiber sheet 1, for example, a metal fiber sheet 1 having a density gradient along the thickness direction may be employed. Further, a multi-layered member of a plurality of metal fiber sheets 1 having different porosities may also be employed. Here, in the fuel cell 100 described in the first embodiment, there is described a configuration of employing of two pieces of metal fiber sheets 1 having different densities in piles, onto the base member 104 and the base member 110.

Although higher density of the base member 104 and the base member 110 provides more efficient transfer of electron in fuel cell 100, the permeability of carbon dioxide generated by the fuel 124, the oxidant 126 and the electrochemical reaction are decreased. On the other hand, although lower density of the base member 104 and the base member 110 provides better permeability for these gases, the catalyst paste may be leaked out from vacant holes of the base member 104 or the base member 110, or the amount of applied materials may be decreased, in the manufacturing the catalyst layer 112 of the catalyst layer 106. Further transfer-property of electron is also decreased.

Consequently, in the present embodiment, the multi-layered member of two ply of the metal fiber sheet 1 is employed as the base member 104 and the base member 110. Then, a metal fiber sheet 1 having higher density is employed for the metal fiber sheet 1 of the side of contacting with the solid electrolyte membrane, or in other words, of the side having the catalyst layer 106 or the catalyst layer 112, and another metal fiber sheet 1 located outside of the fuel cell 100 is that having lower density.

Having the configuration employing the multi-layered members for the base member 104 and the base member 110, the fuel 124 and the oxidant 126 can be introduced to the catalyst electrode with better efficiency, and the discharge of the generated carbon dioxide can be accelerated. Further, since portions required for bonding the catalyst-supporting carbon particles contained in the catalyst layer 106 and the catalyst layer 112 and the metal fiber sheet 1 can be sufficiently ensured, electrons generated in the catalyst electrode can be taken out to the outside of the fuel cell 100 with higher efficiency. In addition, operability in the formation process for the catalyst layer 106 and the catalyst layer 112 onto the surfaces of the base member 104 and the catalyst layer 106 can be improved, and thus sufficient amount of the catalyst can be provided onto the surfaces of the base member 104 and the base member 110.

The present invention has been described above, by illustrating the embodiments. It should be understood by a person having ordinary skills in the art that the disclosure of these preferred embodiments are presented for the purpose of the illustration only, and combinations of these subject matters and/or the processing steps thereof may be modified, and the modified combinations are also within the scope of the invention.

For example, an electrode terminal-attaching portion may be provided to the fuel cell according to the present embodiment, and a plurality of the fuel cells may be jointed through these portions to provide an assembled cell. Suitable configuration of parallel coupling, series coupling and a combination thereof may be adopted to obtain an assembled cell providing a desired electric voltage and capacity. In addition, a plurality of the fuel cells are two-dimensionally arranged to be mutually coupled to provide an assembled cell, or single cell structures 101 may be stacked via separators to form a stack. Even in the case of employing the stack, improved output characteristics can be stably exhibited.

In addition, since the fuel cell of the present embodiment employs the porous metal sheet having improved electric conductivity, electrons generated by the catalytic reaction can be taken out to the outside of the cell with higher efficiency even if a cylinder-shaped configuration or the like is employed, and not limited to the flat plate configuration.

### EXAMPLES

While details of the present invention will be described specifically below by way of illustrating various examples concerning the electrode for the fuel cell and the fuel cell itself, it is not intended to limit the scope of the present invention thereto.

### Example

A metal fiber sheet composed of metal fibers that contain iron, chrome, and silicon as the constitution elements was manufactured. Major components constituting the obtained metal fiber sheet was: 75% wt. of Fe, 20% wt. of Cr and 5% wt. of Si, the thickness was 0.2 mm, and the porosity was within a range of 40% to 60%. In addition, line size of the metal fiber composing the metal fiber sheet was about 30 μm. The manufacture and the evaluation of the fuel cell were performed using this sheet.

A catalyst layer was formed on the surface of a metal fiber sheet as follows. First of all, 5% wt. nafion alcohol solution, commercially available from Aldrich Chemical Company, Inc., was selected for a solid polymer electrolyte, and it was mixed to n-butyl acetate and was stirred so that the quantity of the solid polymer electrolyte would be 0.1 to 0.4 mg/cm² to prepare a colloidal dispersion solution of the solid polymer electrolyte.

Catalyst-supporting carbon fine particles prepared by bonding platinum-ruthenium alloy catalyst having particle diameters of 3 to 5 nm at a weight ratio of 50% onto carbon fine particles (“DENKA BLACK”, commercially available from DENKI KAGAKU KOGYO KABUSHIKI KAISHA) was used for a catalyst of the fuel electrode, and catalyst-supporting carbon fine particles prepared by bonding platinum catalyst having particle diameters of 3 to 5 nm at a weight ratio of 50% onto carbon fine particles (“DENKA BLACK”, commercially available from DENKI KAGAKU KOGYO KABUSHIKI KAISHA) was used for a catalyst of the oxidant electrode. The catalyst-supporting carbon fine particles were added into the colloidal dispersion solution of the solid polymer electrolyte to prepare a paste-like product by using an ultrasonic dispersion apparatus. In this case, the mixing was performed, so that a weight ratio of the solid polymer electrolyte and the catalyst would be 1:1. This paste was applied on the metal fiber sheets at 2 mg/cm² via a screen printing method, and thereafter, the products were dried by heating to prepare electrodes for the fuel cell. These electrodes were hot pressed on both sides of a solid electrolyte membrane “nafion” 112, commercially available from E.I. du Pont de Nemours & Company Inc at a temperature of 130 degree C. and a pressure of 10 kg/cm²to prepare a Membrane Electrode Assembly. In this occasion, an end portion of the metal fiber sheet was protruded from an end portion of the solid electrolyte membrane to form a terminal.

The obtained Membrane Electrode Assembly was mounted to a package for evaluation having a configuration shown in FIG. 8, and output measurements of the fuel cell were carried out. An end portion at the fuel container side was sealed with a sealant, and then a methanol aqueous solution of 10% v/v was introduced into the fuel container. On the side of the fuel electrode, the fuel was supplied through the metal fiber sheet, and from the side of the oxidant electrode, air was naturally taken in. Output of this fuel cell was measured at 1 atom and at a room temperature of 25 degree C., and the result was that output of 0.4 V with current of 100 mA/cm² was obtained. After continuing for 1000 hours, no decrease in the output voltage was measured.

### Comparative Example

A fuel cell having a configuration of providing an end plate was manufactured by using a carbon paper in place of the metal fiber sheet of the fuel cell of the example. Carbon papers (commercially available from Toray Co., Ltd.) having a thickness 0.19 mm were employed as carbon materials for the catalyst electrode, or in other words, for the fuel electrode and the oxidant electrode (gas diffusion electrode), and a Membrane Electrode Assembly was manufactured similarly as in the first example. Then, end plates were provided to the outside of the catalyst electrode, and the end plates of the fuel electrode side and the oxidant electrode side were joined with bolts and nuts, thereby was compressively bonding the catalyst electrode-solid electrolyte membrane complex body with the end plates. A SUS 316 having a thickness of 1 mm was employed for the end plate.

Methanol aqueous solution of 10 % v/v was introduced into the fuel electrode of the obtained fuel cell, and air was supplied into the oxidant electrode. Output of this fuel cell was measured at 1 atom and at a room temperature of 25 degree C., and the result was output of 0.37 V with current of 100 mA/cm². In addition, output thereof after continuing for 1000 hours was 0.35 V.

The above example and comparative example indicate that reduction in the size and the weight and reduction in the thickness of the fuel cell can be achieved by employing the metal fiber sheet in the present embodiment. In addition, it is also found that the fuel cell exhibiting better output characteristics can be achieved. Further, it is also found that this metal fiber sheet has an improved corrosion resistance, and a decrease in the output level of the fuel cell is not occurred for the long term use, thereby improving durability.

1. An electrode for a fuel cell, comprising a metal fiber sheet and catalyst electrically coupled to said metal fiber sheet, wherein said metal fiber sheet comprises an alloy containing, as constituent elements, at least a metal selected from Si and Al, Fe and Cr, wherein content of Cr in said alloy is not less than 5% wt. and not more than 30% wt., and wherein combined contents of Si and Al in said alloy are not less than 3% wt. and not more than 10% wt.

2. The electrode for the fuel cell according to claim 1, wherein a porosity of said metal fiber sheet is not less than 20% and not more than 80%.

3. The electrode for the fuel cell according to claim 1 or claim 2, wherein an average line size of said metal fiber is from 10 to 100 μm.

4. The electrode for the fuel cell according to either of claims 1 or 2, wherein the porosity of one surface of said metal fiber sheet is larger than the porosity of the other surface thereof.

5. The electrode for the fuel cell according to either of claims 1 or 2, wherein said metal fiber sheet is a sintered body of a metal fiber.

6. The electrode for the fuel cell according to either of claims 1 or 2, wherein said catalyst is supported on a surface of a metal fiber that composes said metal fiber sheet.

7. The electrode for the fuel cell according to either of claims 1 or 2, wherein a layer of said catalyst is formed on surface of the metal fiber composing said metal fiber sheet.

8. The electrode for the fuel cell according to either of claims 1 or 2, wherein a catalyst layer containing carbon particles supporting said catalyst is formed on the surface of said metal fiber sheet.

9. The electrode for the fuel cell according to either of claims 1 or 2, wherein the metal fiber composing said metal fiber sheet, has a roughened surface.

10. The electrode for the fuel cell according to either of claims 1 or 2, further comprising a proton conductor having a contact with said catalyst.

11. The electrode for the fuel cell according to claim 10, wherein said proton conductor is an ion exchange resin.

12. The electrode for the fuel cell according to either of claims 1 or 2, wherein at least a part of said metal fiber sheet is hydrophobic treated.

13. A fuel cell, comprising a fuel electrode, an oxidant electrode, and a solid electrolyte membrane sandwiched between said fuel electrode and said oxidant electrode, wherein at least one of said fuel electrode or said oxidant electrode is the electrode for the fuel cell according to either of claims 1 or 2.

14. The fuel cell according to claim 13, wherein said electrode for the fuel cell composes the fuel electrode, and a fuel is directly supplied on the surface of said electrode for the fuel cell.

15. The fuel cell according to claim 13, wherein said electrode for the fuel cell composes said oxidant electrode, and an oxidant is directly supplied on the surface of said electrode for the fuel cell.

16. The fuel cell according to claim 13, wherein a power collection member is not provided.

17. The fuel cell according to claim 14, wherein said electrode for the fuel cell composes said oxidant electrode, and an oxidant is directly supplied on the surface of said electrode for the fuel cell.

18. The fuel cell according to claim 14, wherein a power collection member is not provided.

19. The fuel cell according to claim 15, wherein a power collection member is not provided.
